(19) United States
(12) Patent Application Publication
(10) Pub. No.: US 2009/0324820 A1
(43) Pub. Date: Dec. 31, 2009

(54) Systems, Methods, and Compositions for the Inhibition of Corrosion of Metallic Surfaces

(76) Inventor: Douglas M. Chartier, St. Charles, MO (US)

Correspondence Address: LEWIS, RICE & FINGERSH, LC;ATTN: BOX IP DEPT., 500 NORTH BROADWAY, SUITE 2000, ST LOUIS, MO, 63102, US

(21) Appl. No.: 12/492,695

(22) Filed: Jun. 26, 2009

Related U.S. Application Data
(60) Provisional application No. 61/077,057, filed on Jun. 30, 2008.

(51) Int. Cl. C23F 11/00; B05D 7/22

(52) U.S. Cl. 427/239; 106/14.05; 106/14.44; 106/14.21

(57) ABSTRACT

A chemical and associated systems and methods for creating a gas barrier and microbiologically resistant coating consisting of a quaternary ammonium salt, nano-clay and oxygen scavenger to protect metallic surfaces from microbiologically influenced corrosion, oxygen and acid gas (hydrogen sulfide and carbon dioxide) corrosive processes.

### CROSS REFERENCE TO RELATED APPLICATION(S)

This application claims benefit of U.S. Provisional Patent Application Ser. No. 61/077,057 filed Jun. 30, 2008, the entire disclosure of which is herein incorporated by reference.

### BACKGROUND

1. Field of the Invention

The present invention generally relates to corrosion inhibitor coatings containing quaternary ammonium salts, nano-clays and potentially other materials which are applied to corrodible metallic surfaces and systems and methods for using the same.

2. Description of the Related Art

Piping and other metal systems in contact with water, air, or other chemicals are often subject to chemical corrosion where the metals' contact with the substance can cause a reaction altering the chemical structure of the metal. The most well known type of chemical corrosion of metal is rust, or the oxidation of iron However, most forms of metal can corrode in the presence of certain chemicals with oxygen, hydrogen sulfide and carbon dioxide gas corrosion being some of the common forms of corrosion. Oxygen gas corrosion is present generally wherever metallic composites are exposed to atmospheric or oxygen laden water conditions. Hydrogen sulfide and carbon dioxide gas corrosion are common in oil and gas operations including, pipelines, refineries and production operations. These later types of corrosion are often called, “acid gas” corrosion.

In addition to chemical corrosion, corrosion can also be caused by microbial growth on the metal which is often referred to as MIC (Microbiologically Influenced Corrosion). MIC generally causes localized and pitting corrosion which can be hard to detect until the system fails. MIC is most commonly problematic in piping systems and occurs in a variety of industrial and other venues such as, but not limited to, fire protection sprinkler pipeline systems, water treatment facilities, cooling towers, oil and gas pipelines and production equipment, nuclear power plants, and ocean and river shipping vessels.

Because corrosion can cause structural failure of metallic systems, a number of systems and methods have been proposed to try and reduce or eliminate corrosion in a variety of circumstances. In piping systems, treatment of the internal surface of the pipe, which is often not readily accessible once the system is installed, can be difficult. This can be particularly true in generally sealed piping systems such as fire protection systems which are often filled with stagnant, relatively inaccessible water where access requires the significant expense of draining and refilling the system. Further, such systems may include moving parts and components made of different constructing, making it difficult to find a universal solution. To try and resolve such concerns, a number of materials and methods for applying them to metal surfaces have been developed.

U.S. Pat. No. 6,758,282 by David S. Pliner et al discloses the application of an antibacterial coating, applied to the internal surfaces of piping for sprinkler systems during the manufacturing process; the coating consists of a quaternary ammonium salt in combination with a filming amine(s) and/or synthetic oil. While the Pliner et al patent addresses the installation of an antibacterial coating during manufacture of fire protection tubing and piping, it does not inhibit against oxygen gas corrosion during the drying or curing time of the coating. The National Fire Protection Association (NFPA) requires all tubing and piping used in fire protection systems to be free of all corrosion prior to installation. The filming amines used in the Pliner et al patent are known to create chemical corrosion on ferrous metals when used in high concentrations. This is due to their surfactant and cleaning properties which leave the ferrous metal exposed for dissolved oxygen within the coating composition to promote oxygen corrosion. Thus, the Pliner et al. composition can be unusable for certain systems such as fire protection systems.

U.S. Pat. No. 6,076,536 to Ludwig et al. discloses the introduction of an anti-microbial agent into the water residing in a water piping system such as a fire protection system. Ludwig et al. provide that the agent is added after the system has been chemically cleaned in a previous step and passivated in a second step. This multi-step cleaning/passivation procedure requires isolation and opening of the system. The anti-microbial treatment also is somewhat exotic and the process presents the possibility of exposing humans to potentially harmful levels of the anti-microbial agent in the event the system is activated or opened for servicing.

U.S. Pat. No. 5,803,180 to Talley teaches stagnant high pH (pH value 9.5 to 11.0) water to retard microbial growth. This method also involves multi-step preparation of the pipeline and requires extensive procedures to electrically isolate ferrous members and nonferrous members of the piping system to prevent galvanic corrosion. This process also presents the possibility of exposing humans to the caustic fluid if the system is activated or opened for servicing.

Another method of microorganism control within fire protection systems is detailed in U.S. Pat. No. 6,221,263 to Pope, et al. Water is automatically treated as it enters a fire protection sprinkler system (FPS) to kill microbes introduced with the water. Again, use of an anti-microbial treatment presents the possibility of exposing humans to potentially harmful levels of the anti-microbial agent in the event the system is activated or opened for servicing. U.S. Pat. Nos. 6,517,617 and 6,841,125, Chartier, et al., teach using a foamed composition containing quaternary ammonium salts and other additives as an anti-microbial coating for fire sprinkler systems, pipelines, etc.

While specific anti-microbial agents to control microbe build up in piping systems will generally be in compositions which are designed to be anti-microbial, some anti-corrosive chemical agents are known to produce coatings that also have anti-microbial properties. An example of an anti-microbial coating is disclosed in U.S. Pat. No. 6,030,632 to Sawan et al. Some anticorrosive agents which have been applied to pipelines are discussed in U.S. Pat. No. 6,117,558 to Spellane et al., U.S. Pat. No. 6,042,750 to Burlew, and U.S. Pat. No. 4,197,091 to Gainer. These patents teach the application of coatings or polymeric coatings which contain or are the reaction product of aldehydes, amines, carboxylic acids (both mono and poly functional), pyridines, imidazols, anilines, fatty acids both saturated and unsaturated, diamines, and aliphatic quaternary ammonium salts. These coatings often result in micro-cracking over time, allowing oxygen, hydrogen sulfide, carbon dioxide and corrosion causing bacterium access to corrodible metal.

While chemical treatments have been discussed above, in some circumstances chemical treatments can require taking a portion of the pipe out of service while it is being treated. Further, many proposed chemical compositions are hazardous to use and dangerous for the personnel exposed to them. In systems such as fire protection systems this can also provide for resultant water in the system to have harmful chemical properties which can be hazardous to fire fighters or those present in the building when the system is activated in addition to those who service such systems.

Another typical method of cleaning pipelines involves using mechanical devices to physically remove material. For example, in oil transmission pipelines it is common to force a “pig” through the line to remove sludge clinging to the walls. However, in some sections of pipeline, no facilities for “pigging” the line are installed.

Other methods of mechanically treating pipelines have been detailed in U.S. Pat. No. 5,046,289 to Bengel et al., U.S. Pat. No. 5,735,955 to Monaghan et al., and U.S. Pat. No. 5,213,120 to Dickson. In the Bengel et al. patent, a mechanical head which ablates the surface of the pipe is passed down through the pipe. This approach is impractical for long lengths of pipe such as an oil transmission line, and costly for a closed system such as a fire protection system. Both the Monaghan et al. and Dickson provide a dispersion head passed down the pipeline, which generates foam containing the substance used to treat the pipeline. Contact of the foam with the interior surface of the pipeline disperses the treatment agent on the interior of the pipeline surface.

### SUMMARY

The following is a summary of the invention in order to provide a basic understanding of some of the aspects of the invention. This summary is not intended to identify key or critical elements of the invention or to delineate the scope of the invention. The sole purpose of this section is to present some concepts of the invention in a simplified form as a prelude to the more detailed description that is presented later.

The present invention generally relates to an environmentally friendly, antibacterial, biodegradable, gas barrier, corrosion inhibitor coating containing quaternary ammonium salts, nano-clays and FDA approved oxygen scavengers to be applied to corrodible metallic surfaces. The coatings are to prevent oxygen (O₂), hydrogen sulfide (H₂S) and carbon dioxide (CO₂) acid gas corrosion plus bio-corrosion during manufacturing, installation, testing and usage of metallic pipes and tubing used in fire sprinkler systems, pipelines, industrial water treatment, cooling towers, oil & gas, applications, nuclear power systems, shipping, barges and pulp & paper operations. Application may be by an aqueous solution, neat, micro-emulsion or as a foamed composition with air, natural gas or nitrogen.

Described herein, among other things, is a chemical system to create a gas barrier and microbiologically impervious coating consisting of a quaternary ammonium salt, nano-clay and oxygen scavenger to protect metallic surfaces from microbiologically influenced corrosion, oxygen and acid gas (hydrogen sulfide and carbon dioxide) corrosive processes.

In an embodiment of the chemical system the composition is foamed with air for application.

In an embodiment of the chemical system the composition is foamed with nitrogen for application.

In an embodiment of the chemical system the composition is foamed with natural gas for application.

In an embodiment of the chemical system the composition is a hydrophilic aqueous additive for application.

In an embodiment of the chemical system the composition is applied to metallic surfaces dispersed in a micro-emulsion consisting of a hydrocarbon based solvent, co-solvent and water.

In an embodiment of the chemical system the nano-clay is a dioctahedral smectite, montmorillonite and/or nontronite.

In an embodiment of the chemical system the nano-clay is chlorite.

In an embodiment of the chemical system the nano-clay is illite.

In an embodiment of the chemical system the nano-clay is kalonite.

In an embodiment of the chemical system the oxygen scavenger is a catalyzed sulfite.

In an embodiment of the chemical system the oxygen scavenger is ascorbic acid.

In an embodiment of the chemical system the oxygen scavenger is N-ethyl-N-hydroxy-ethanamine.

In an embodiment of the chemical system the oxygen scavenger is α-tocopherol.

In an embodiment of the chemical system the quaternary ammonium salt is a benzylcoco alkyldimethyl quaternary amine C8-C18.

In an embodiment of the chemical system the quaternary ammonium salt is a Di-C10 dimethyl ammonium chloride.

In an embodiment of the chemical system the quaternary ammonium salt is a monomer with a carbon chain of C8-C (8+n).

In an embodiment of the chemical system the quaternary ammonium salt is an aliphatic structure.

In an embodiment of the chemical system the quaternary ammonium salt is a benzene ring based structure.

In an embodiment the chemical system is applied on the inner wall of metallic piping and tubing used in fire protection systems during manufacturing and in place usage of said systems, piping and tubing.

In an embodiment the chemical system is applied on the inner wall of metallic piping and tubing used in pipelines, oil and gas tubing & casing and API piping and tubing; during manufacturing and in place usage of said piping and tubing stock.

In an embodiment the chemical system is applied to fabricated metallic structures used in fire sprinkler systems.

In an embodiment the chemical system is used in oilfield & gas production, pipeline and refineries of metallic fabricated structures.

In an embodiment the chemical system is used in industrial water treatment of metallic fabricated structures.

In an embodiment the chemical system is applied on the outer wall of metallic piping and tubing used in fire protection systems during manufacturing and in place usage of said systems and piping and tubing stock.

In an embodiment the chemical system is applied on the outer wall of metallic piping and tubing used in pipelines, oil and gas tubing & casing and API piping during the manufacturing and in place usage of said piping and tubing stock.

In an embodiment the chemical system is applied as a primer coating, before a final coating is applied, to create a gas barrier and as a biostatic barrier for microbiologically influenced corrosion bacterium.

In an embodiment of the chemical system the metallic surface includes ferrous iron.

In an embodiment of the chemical system the metallic surface is galvanized (zinc coated).

In an embodiment of the chemical system the metallic surface includes stainless steel.

In an embodiment of the chemical system the metallic surface includes copper.

In an embodiment of the chemical system the metallic surface includes zinc.

In an embodiment of the chemical system the metallic surface includes brass.

In an embodiment of the chemical system the metallic surface includes aluminum.

In an embodiment of the chemical system the metallic surface is flat stock.

In an embodiment of the chemical system the metallic surface is tubing, piping or casing.

In an embodiment of the chemical system the metallic surface is a metallic fabricated product.

In an embodiment of the chemical system the metallic surface includes at least one of: metallic flat stock, piping, tubing, or casing.

### DESCRIPTION OF THE PREFERRED EMBODIMENT(S)

This disclosure provides systems, methods, and compositions for inhibiting microbial corrosion on metallic systems which are generally environmentally friendly, non-toxic and non-regulated. The compositions, systems, and methods, may be used for passivation of piping systems during manufacturing, hydro-testing, and afterwards, to protect such systems against oxygen, hydrogen sulfide, carbon dioxide gases and MIC corrosion.

The surfaces of many metals and specifically ferrous metals are known to have an incomplete natural passivation layer formed by oxygen molecules from the atmosphere on the exposed metal. This natural passive layer is not as complete as it is with stainless steel and aluminum. Oxygen, hydrogen sulfide, carbon dioxide gases and biologically corrosive bacterium can penetrate this layer with relative ease. The layer of passivation is complete among stainless steels and gives them their non-corrosive properties. Even though this mechanism is very efficient against chemical and acid gas corrosion, it does not protect against microbe attachment which causes microbiological corrosion to occur. Aerobic bacterium may penetrate the oxide layer and expose the metal surface for future microbiological or acid gas corrosion.

The compositions described herein comprise clay particles, in a nano-form, which are used to form a generally non-permeable barrier to oxygen, hydrogen sulfide, carbon dioxide gases and microbiologically influencing corrosive bacterium which is placed upon the metallic surface using methodologies known to those of ordinary skill in the art. These nano-form clay particles are generally referred to as “nano-clays” herein and are typically about 1 nanometer (nm) thick platelets with 300 to more than 600 nanometers of surface area.

The nano-clay composite is preferably montmorillonite which can comprise an about 1 nm thick aluminosilicate layer surface-substituted with metal cations and stacked in about 10 micrometer (μm) sized multi-layer stacks. However, depending on embodiment, the nano-clays can be, but are not limited to, nano forms of smectites (including dioctahedral smectites such as, but not limited to, montmorillonite and nontronite), chlorites, illites, and kaolins (including, but not limited to kalonite). They also may be provided in any acceptable nano form.

In order to provide for adhesion of the nano-clay particles to the metallic surfaces, the nano-clays are generally provided in composition with a cationic quaternary ammonium salt (quaternary amine) which acts to improve surface adhesion. In one embodiment, biodegradable quaternary ammonium salts are used to decrease environmental concerns in disposal of the material and make the resultant water safer for human and animal contact.

The oxide layer of the ferrous or non-ferrous metal generally has a negative (−) or anionic charge and has a natural affinity for cationic quaternary ammonium salts (which have a positive [+] or cationic charge). Nano-clays have a negative (−) or anionic charge, and are naturally attracted to the cationic quaternary ammonium salts. Thus, this combination provides for natural attraction to attract the nano-clays to the surface of the oxide layer of the target metal. Plus, quaternary amines are believed to compact the clay's plates of hydrous aluminum phyllosilicates by cation exchange, drawing the clay's plates closer to each other in proximity and reducing the overall height of the clay coating.

It is generally preferred that there be excess quaternary ammonium salts in the composition, that is quaternary ammonium salt not used in cation exchange with the nano-clay particles makes the entire chemical system cationic in nature and thus attracted to the metallic surface on which it is placed. When exposed to the metal surface, the overall cationic quaternary amines and nano-clay particles, therefore, form a tight matrix with the anionic oxygen layer on the metal composite. This generally provides a substantially complete layer or film of passivation and a bio-static coating which acts as a barrier against chemical, acid gas, oxygen and biological penetration. The nano-clay structures lay flat on the metal surface (attracted by the quaternary amine salts) and form a gas barrier to the acid gases hydrogen sulfide, carbon dioxide and oxygen. The nano-clays also present a non-organic barrier to microbiologically corrosive bacterium.

As the nano-clays are only about one nanometer thick in the resultant film, they generally do not interfere with the function of the metallic surface, and can be used on all kinds of metal structures including those having moving parts, such as, but not limited to valves, faucets, and sprinkler heads and can also be used with parts requiring complex construction and fabrication techniques or that utilize small components.

In addition to providing for attraction of the composition to the metal surface when provided in excess, the quaternary amines are also believed to lower the surface tension of the aqueous phase and disrupt the natural osmotic pressure between bacteria cell walls and medium, affecting nutrient and waste transfer of the biological process which also directly results in death of potentially corrosive bacteria. Thus, the quaternary amines provide anti-biological properties as well as assisting in the formation of the nano-clay film and can work in conjunction with the nano-clay film to resist MIC.

The composition may be introduced to the metal surface in any manner known to one of ordinary skill. In an embodiment, the composition is introduced into the system to be passified, within an aqueous suspension or other aqueous composition. Generally, so that the water in the composition does not introduce contaminants including potentially harmful microbes, the water used will usually be purified and will, in an embodiment, meet the following criteria: TDS>200 ppm, pH range 6.8 to 7.2, Total Hardness>50 ppm, Chloride>10 ppm. Water of this type can be produced from commercial deionization units using potable water as an initial source

The compositions can be supplied as bulk liquids, droplets, and foams and may be supplied in a concentrated form where water (and or gas to provide for foaming) is to be added later to dilute them and/or to place them in their dispersion form. The compositions can be sprayed, brushed, foamed or otherwise applied to a metal surface directly. Alternatively metallic objects may be dipped into the composition to apply it.

In still further embodiments, the composition may be an additive to water which is being used in conjunction with the metallic structure as part of normal usage. For example, concentrates of the composition may be added to water used to pressure test vessels; stored in fire sprinkler systems, pipelines, piping, tubing and casing; or used during hydro-testing.

In an embodiment, the composition would be applied during manufacture of the metallic surfaces or at least applied prior to their installation. However, it may also be applied to systems which are already in place through various methods. These can include placing it in water which is stored or run through the systems, which can be common in fire-protection systems, or it may be added or used as part of other maintenance operations. For example, high-density foams including the composition may be used to dislodge and remove existing corrosion and then apply the desired coating to the surface in one step.

While the use of a foam dispersion head to apply foam within a pipeline has the same shortcomings as the use of a mechanical cleaning head, the use of a foam to carry the treating agent down a pipeline and bringing the treating agent against all the interior surfaces is something that can be done with minimal support equipment and no particular line fittings. Thus, in an embodiment, a slug of foam may be used to disperse agents for treating the interior of a pipeline, fire protection system, or similar system in situ.

The primary layer of quaternary amine/nano-clay matrix may be disrupted by normal operational conditions of fire protection systems and pipelines which may have moving water or other moving structures which can mechanically abrade the treated surfaces. System operation, system testing, velocity of fluids and particulate abrasion may dislodge the in-place coatings over time. Such disruptions in the passivity layer, however, will generally create an ionic imbalance on the surface of the coating due to the stripping away of the coating material. Therefore, a maintenance system provided with an overage of composition (which in an embodiment is a formulation with greater than 50 parts per million (50 ppm)) to water which is maintained in the system can provide that there is always available composition which will be attracted to any mechanically generated holes in the surface and assists in maintaining the integrity of an internal pipe wall or other surface that it is in contact therewith.

In an embodiment, chemical formulations used in the primary application may be used for maintenance procedures as well and can be installed on a regular basis to provide for ongoing treatment of the system.

In a still further embodiment, the composition may include additional materials. In one embodiment, the additional material can comprise an oxygen scavenger. Inclusion of an oxygen scavenger adds another mechanism of preventing oxygen gas from reaching the metallic surface to perform oxidation. Catalyzed sulfite, ascorbic acid, N-ethyl-N-hydroxy-ethanamine and α-tocopherol are all exemplary oxygen scavengers which may be used in embodiments of the compositions contemplated herein. It is generally preferred that FDA (Food and Drug Administration) approved oxygen scavengers (which are often food grade) be utilized as this can maintain the composition at a relatively low toxicity making it safer to handle and improving ease of its disposal.

The inclusion of other additives to the above compositions can be desirable where a specific additional property of the composition can be desired. They can also be included to improve performance under specific conditions normally found in the manufacture and usage of iron sheet, plate, piping and other products. The specific additives which may be included in any embodiment will depend on the specific conditions present and may comprise any or all of those discussed in Table 1 as well as other materials whose inclusion would be beneficial as would be known to those of ordinary skill in the art.

TABLE 1

| | |
|---|---|
| Tetrakis (Hydroxymethyl) Phosphonium | Additive for increased bio-static activity of |
| Sulfate | coating |
| Citric Acid, | Additive for chelating of dissolved iron, |
| | calcium, and magnesium |
| Sulfamic Acid | Additive for dissolving scale & tubercles |
| Sodium EDTA-Di, Tri, and Tetra sodium | Additive for chelating of dissolved iron, |
| salts of ethylendediaminetetraacetic acid | calcium and magnesium |
| Acetic Acid, | Additive for dissolving scale & tubercles |
| Molybdenum Disulfide | Additive to make layer of passivity more |
| | tenacious in high velocity, often used |
| | systems |
| Sodium Thiosulfate | Oxygen scavenger used in systems where |
| | aeration of aqueous system exists in the |
| | process |
| Sodium Gluconate | Additive used as chelating agent and |
| | sequestering in high temperature (<200 F.) |
| | situations |
| Sodium Dodecylbenzenesulfonate | Surfactant used to disperse other additives |
| | within the formulation |
| Sodium Metaphosphates | Additive used as a scale inhibitor and |
| | sequesterant in systems where hard water |
| | is present |
| Sodium Phosphates-mono and dibasic | Additive used as a scale inhibitor and |
| | sequesterant where hard water is present |
| Sodium Alkane Sulfonate | Surfactant used to disperse other additives |
| | within the formulation |
| Sodium Borate & Sodium Nitrite | Additives to make layer of passivity more |
| | tenacious in high velocity, often used |
| | systems |
| Sodium Metasilicate | Additive used to make layer of passivity |
| | more tenacious in high velocity, often used |
| | systems |
| Sodium-N-methyl-oleoyltaurate | Surfactant used to disperse other additives |
| | within the formulation |
| Sodium Orthophosphates | Additive used to chelate dissolved iron, |
| | calcium, and magnesium |
| Sodium Orthosilicate | Additive used to make layer of passivity |
| | more tenacious in high temperature |
| | (<200 F.) high velocity, often used systems |
| Phosphate Esters | Additive used as a scale inhibitor and scale |
| | crystal distorter where hard water is |
| | present) |
| Sodium NTA | Additive used as a chelating & |
| | sequestering agent where hard water is |
| | present) |
| Polyvinylpyrrolidone | Additive used for increased bio-static |
| | activity of coating) |
| Zinc Gluconate | additive to aid in passification coating |
| Polydimethylsiloxane | food grade defoamer additive |
| Catfoam | Cationic Foamer |
| Monethanol Amine | H2S & CO2 absorber |
| Diethanolamine | H2S & CO2 absorber |
| Methyl Diethanolamine | H2S & CO2 absorber |
| Sodium Bicarbonate | pH adjustment |

As the applied coating is very thin, generally transparent, anticorrosive, oxygen, acid gas and microbial resistant, it may be sprayed, dipped or otherwise applied to painted or otherwise coated, taped or hydrocarbon coated to materials other than metals which are subject to corrosion or microbial growth such as, but not limited to, concrete. It may also be integrated into paints, coatings, tape, cement, or concrete and may be used as is or may be applied using those carriers on other materials. During the manufacturing of paints and coatings, it can be added as a batch additive after the primary formulation is constituted. During the manufacturing of tapes, it can be added to the base adhesive formulation after the primary formulation is constituted. During the hydration of cements and concrete, it may be added to the makeup water before hydration. It can be added continuously or periodically in manufacturing and other industrial processes where needed.

Generally, the compositions discussed herein inhibit oxygen gas corrosion and provide a biostatic coating applied during the manufacture of any metallic constructs. It is believed that constructs such as, but not limited to, fire sprinkler pipe, oil and gas production tubing, casings, pipelines and related system accessories of ferrous iron, stainless steel, copper and/or brass can all be treated with the compositions discussed herein.

The compositions can also generally be used to create a microbial barrier and inhibit oxygen gas corrosion on the inner walls of in situ wet and dry fire protection systems or other systems having water stored or transported therein. This can serve to reduce the likelihood of sprinkler head or other valve fouling by-products, iron sulfides, oxides, etc, and biomass remnant and tubercle formation in these systems.

The composition may also serve to create a microbial barrier and inhibit oxygen gas and acid gas (CO₂ and H₂S) corrosion on the inner walls of in place oil and gas production equipment, pipelines and refinement of petroleum and natural gas products or other systems which are exposed to acid gas corrosion.

The compositions are also believed to inhibit the formation of pinhole and loss of integrity leaks caused by corrosion from microbial, chemical, oxygen and acid gas activity, within in place fire sprinkler systems, oil and gas tubing & casing, pipelines and system accessories of ferrous iron, stainless steel, copper and/or brass commonly used in fire sprinkler systems, industrial water systems and oil and gas operations.

Generally, the corrosion agent may comprise the following relative percentage of chemicals: Quaternary amine salt: 0.5% to 50% by weight, Nano-Clay: 0.1% to 25% by weight, Oxygen Scavengers and/or other additives: 0 to 10% by weight and Purified Water: 10% to 85% by weight. As discussed above, in an alternative embodiment the composition may be supplied without water or with reduced water in a concentrate form whereby the composition would be mixed with water to the above ratios prior to applying. This could be either to form a composition for spraying or as being added to water for use in the target system.

It is also contemplated that the composition may be supplied to the target system as a foam. In a foam, virtually any gas can be injected to the composition to create the foam including air, nitrogen, or other gases. The composition can also be foamed and carried by a material already present in the target system, for example natural gas in a gas pipeline system.

It should be recognized that specific formulations will depend on specific applications and desired results as well as potential cost concerns. However, the following paragraphs provide for a number of exemplary embodiments which are believed to be particularly useful in certain situations. It is generally preferred that food grade chemicals be used, whenever possible, as this makes it easier to insure that the compositions will more easily meet any relevant water quality or other standards. Health and safety considerations would also be considered for the applicant and the general public. All formulations will also preferably take into consideration the environment within they will be used and how the composition is to be applied. The formulations given may be modified and customized to provide optimal performance for a specific purpose.

With these general considerations in mind, Table 2 provides for currently preferred compositions for various types of applications.

TABLE 2
Preferred Non-Foaming Additive Formulation

| | |
|---|---|
| Di-C10 dimethyl ammonium chloride | about 10% to about 25% by weight |
| Montmorillonite (Cloisite ™ Na+) | about 1.5% to about 5% by weight |
| Polydimethylsiloxane (food grade) | about 0.5% to about 2% by weight |
| Purified Water | about 68% to about 88% by weight |

More Preferred Non-Foaming Additive Formulation

| | |
|---|---|
| Benzylcoco alkydimethyl quaternary amine C8-C18 | about 10% to about 25% by weight |
| Montmorillonite (Cloisite ™ Na+) | about 1.5% to about 5% by weight |
| Polydimethylsiloxane (food grade) | about 0.5% to about 2% by weight |
| Purified Water | about 68% to about 88% by weight |

Most Preferred Non-Foaming Additive Formulation

| | |
|---|---|
| Benzylcoco alkydimethyl quaternary amine | about 10% to about 25% by weight |
| C8-C18 | |
| Montmorillonite (Nanocor ™) | about 1.5% to about 5% by weight |
| Polydimethylsiloxane (food grade) | about 0.5% to about 2% by weight |
| Purified Water | about 68% to about 88% by weight |

Preferred Foaming Additive Formulation

| | |
|---|---|
| Di-C10 dimethyl ammonium chloride | about 10% to about 25% by weight |
| Montmorillonite (Cloisite ™ Na+) | about 1.5% to about 5% by weight |
| Purified Water | about 68% to about 88% by weight |

More Preferred Foaming Additive Formulations

| | |
|---|---|
| Benzylcoco alkydimethyl quaternary amine | about 10% to about 25% by weight |
| C8-C18 | |
| Montmorillonite (Nanocor ™) | about 1.5% to about 5% by weight |
| Purified Water | about 68% to about 88% by weight |

Most Preferred Foaming Additive Formulations

| | |
|---|---|
| Benzylcoco alkydimethyl quaternary amine | about 10% to about 25% by weight |
| C8-C18 | |
| Montmorillonite (Nanocor ™) | about 1.5% to about 5% by weight |
| Catfoam (Cationic Foamer) | about 0.5% to about 5% by weight |
| Purified Water | about 68% to about 88% by weight |

Preferred Non-Foaming Low pH Additive Formulations

| | |
|---|---|
| Benzylcoco alkydimethyl quaternary amine | about 10% to about 25% by weight |
| C8-C18 | |
| Montmorillonite (Nanocor ™) | about 1.5% to about 5% by weight |
| Sulfamic Acid (food grade) | about 7.5% to about 10% by weight |
| Sodium NTA (food grade) | about 1% to about 5% by weight |
| Polydimethylsiloxane (food grade) | about 0.5% to about 2% by weight |
| Purified Water | about 53% to about 79.5% by weight |

More Preferred Non-Foaming Low pH Additive Formulations

| | |
|---|---|
| Benzylcoco alkydimethyl quaternary amine | about 10% to about 25% by weight |
| C8-C18 | |
| Montmorillonite (Nanocor ™) | about 1.5% to about 5% by weight |
| Citric Acid (food grade) | about 2.5% to about 10% by weight |
| Sulfamic Acid (food grade) | about 7.5% to about 10% by weight |
| Sodium NTA (food grade) | about 1% to about 5% by weight |
| Polydimethylsiloxane (food grade) | about 0.5% to about 2% by weight |
| Purified Water | about 43% to about 77% by weight |

Most Preferred Non-Foaming Low pH Additive Formulations

| | |
|---|---|
| Benzylcoco alkydimethyl quaternary amine | about 10% to about 25% by weight |
| C8-C18 | |
| Montmorillonite (Nanocor ™) | about 1.5% to about 5% by weight |
| Zinc Gluconate | about 1.5% to about 5% by weight |
| Polyvinylpyrrolidone (technical grade) | about 1.5% to about 5% by weight |
| Citric Acid (food grade) | about 2.5% to about 10% by weight |
| Sulfamic Acid (food grade) | about 7.5% to about 10% by weight |
| Sodium NTA (food grade) | about 1% to about 5% by weight |
| Polydimethylsiloxane (food grade) | about 0.5% to about 2% by weight |
| Purified Water | about 33% to about 74% by weight |

Preferred Foaming Low pH Additive Formulations

| | |
|---|---|
| Benzylcoco alkydimethyl quaternary amine | about 10% to about 25% by weight |
| C8-C18 | |
| Montmorillonite (Nanocor ™) | about 1.5% to about 5% by weight |
| Sulfamic Acid (food grade) | about 7.5% to about 10% by weight |
| Sodium NTA (food grade) | about 1% to about 5% by weight |
| Catfoam (Cationic Foamer) | about 2% to about 10% by weight |
| Purified Water | about 45% to about 88% by weight |

More Preferred Foaming Low pH Additive Formulations

| | |
|---|---|
| Benzylcoco alkydimethyl quaternary amine | about 10% to about 25% by weight |
| C8-C18 | |
| Montmorillonite (Nanocor ™) | about 1.5% to about 5% by weight |
| Citric Acid (food grade) | about 2.5% to about 10% by weight |
| Sulfamic Acid (food grade) | about 7.5% to about 10% by weight |
| Sodium NTA (food grade) | about 1% to about 5% by weight |
| Catfoam (Cationic Foamer) | about 2% to about 10% by weight |
| Purified Water | about 35% to about 75.5% by weight |

Most Preferred Foaming Low pH Additive Formulations

| | |
|---|---|
| Benzylcoco alkydimethyl quaternary amine | about 10% to about 25% by weight |
| C8-C18 | |
| Montmorillonite (Nanocor ™) | about 1.5% to about 5% by weight |
| Zinc Gluconate | about 1.5% to about 5% by weight |
| Polyvinylpyrrolidone (technical grade) | about 1.5% to about 5% by weight |
| Citric Acid (food grade) | about 2.5% to about 10% by weight |
| Sulfamic Acid (food grade) | about 7.5% to about 10% by weight |
| Sodium NTA (food grade) | about 1% to about 5% by weight |
| Catfoam (Cationic Foamer) | about 2% to about 10% by weight |
| Purified Water | about 25% to about 74% by weight |

In addition to the general formulas above, applications in certain environments can also influence the composition as discussed below.

The environment within a natural gas pipeline has ideal conditions for various types of MIC causing bacteria to establish colonies. A foam formulation may be added by continuous injection or by spearheading with a cleaning pig. In both cases, foam is created within the natural gas energy derived from the flow velocity. Creation of high density foam assures that all internal wall surfaces will be contacted with the formulation for the passifying mechanism to occur. The formulation of Table 3 is preferred for problems encountered in natural gas pipelines:

TABLE 3

| | |
|---|---|
| Benzylcoco alkydimethyl quaternary amine | about 25% by weight |
| C8-C18 | |
| Montmorillonite (Nanocor ™) | about 2.5% by weight |
| Purified Water | about 67% by weight |
| Catfoam (Cationic Foamer) | about 1% by weight |
| Methyl Diethanolamine | about 2.0% by weight |
| Sodium Metasilicate (technical grade) | about 2.5% by weight |

The environment within an oil or petroleum pipeline is anaerobic in nature. Anaerobic MIC bacteria, such as sulfate reducing bacteria (SRB), thrive in such conditions. The oil and/or petroleum organic base offers nutrients for the bacterium to enhance viability. Some oil and petroleum pipelines contain acid gases, such as hydrogen sulfide and carbon dioxide. Extreme corrosion can be the result of an exposure to these gasses and anaerobic bacteria. The formulation of Table 4 is preferred to be added and adjusted through batch or continuous addition as a liquid in such systems:

TABLE 4

| | |
|---|---|
| Benzylcoco alkydimethyl quaternary amine | about 25% by weight |
| C8-C18 | |
| Montmorillonite (Nanocor ™) | about 2.5% by weight |
| Purified Water | about 66% by weight |
| Methyl Diethanolamine | about 2.5% by weight |
| Sodium Metasilicate (technical grade) | about 2.5% by weight |
| Polydimethylsiloxane (food grade) | about 0.5% by weight |
| Sodium-N-methyl-oleoyltaurate (technical | about 1.0% by weight |
| grade) | |

Tubing is created by using flat stock on a roll. It is twisted and fused into a tube as it progresses down the manufacturing line and welded as the twisted surfaces come into contact with each other. Soon, after the weld has healed, a formulation can be sprayed onto the internal tubing walls using a 360 degree spray wand. An internal pipe coating is sometimes added in this manner. This creates several problems which must be addressed for the formulation: The biostatic, oxygen gas inhibiting coating must be able to withstand the residual heat from the spot welding. Foaming is also not desired. The liquid formulation of Table 5 is generally preferred in the manufacturing of fire sprinkler pipe and tubing:

TABLE 5

| | |
|---|---|
| Benzylcoco alkydimethyl quaternary amine | about 25% by weight |
| C8-C18 | |
| Montmorillonite (Nanocor ™) | about 2% by weight |
| Purified Water | about 67% by weight |
| Polydimethylsiloxane (food grade) | about 0.5% by weight |
| Sodium Orthosilicate (technical grade) | about 3.5% by weight |
| Catalyzed Sulphite | about 2% by weight |

Fire sprinkler piping and tubing is sometimes cooled by an aqueous bath during manufacture from cold rolled stock. Foaming is not desired during the operation. The formulation of Table 6 is preferred to be added at a dosage of about 2.5% by weight to the cooling bath for ionic coating attachment to occur to the surface of the metallic piping or tubing:

TABLE 6

| | |
|---|---|
| Benzylcoco alkydimethyl quaternary amine | about 25% by weight |
| C8-C18 | |
| Montmorillonite (Nanocor ™) | about 2% by weight |
| Purified Water | about 65.5% by weight |
| Polydimethylsiloxane (food grade) | about 0.5% by weight |
| Sodium Orthosilicate (technical grade) | about 3.5% by weight |
| Catalyzed Sulphite | about 2.0% by weight |
| Sodium-N-methyl-oleoyltaurate (technical | about 1.5% by weight |
| grade) | |

Casing, pipe and tubing manufactured for oil and gas production, transportation and refining is coated with the same process described in the Pliner, et al., patent, the entire disclosure of which is herein incorporated by reference. The MIC corrosion problem is very serious within the oil and gas industry as spores of MIC causing bacteria are found within the producing formations and in-situ waters. Oxygen gas corrosion is prevalent during the drying time of coatings.

Tubing and pipe is created by using flat stock on a roll. It is then formed into a tube as it progresses down the manufacturing line and spot welded. Immediately after the weld has healed, the liquid formulation is sprayed onto the internal tubing walls to prevent oxygen gas corrosion using a 360 degree spray wand and dried. This comprises many problems which must be addressed for the formulation. The formulation must be heat stabilized to encounter the high temperatures during the welding process and a gas barrier must be formed to alleviate oxygen gas corrosion. The formulation of Table 7 is generally preferred in the manufacturing of oil and gas pipe and tubing:

TABLE 7

| | |
|---|---|
| Benzylcoco alkydimethyl quaternary amine | about 25% by weight |
| C8-C18 | |
| Montmorillonite (Nanocor ™) | about 2.5% by weight |
| Purified Water | about 64.5% by weight |
| Polydimethylsiloxane (food grade) | about 0.5% by weight |
| Sodium Orthosilicate (technical grade) | about 3.5% by weight |
| Sodium Thiosulfate (technical grade) | about 2% by weight |
| N-ethyl-N-hydroxy-ethanamine | about 2% by weight |

Dry fire sprinkler systems are systems which are not filled with water but pressurized air or other gases, such as nitrogen. The water delivery system is activated when a drop in air pressure, caused by sprinkler head activation, occurs. Their basic function is to extinguish fires and assure that the possibility of water damage does not occur to property by a leak within the system. However, they are periodically tested with high pressure water. Several problems occur because of their design: There is always some residual water left in the system. The residual water is usually over pressured with air, alternatively providing ideal conditions for both aerobic MIC bacteria growth, and promoting anaerobic MIC growth under the aerobic bacteria's biofilm. Oxygen gas corrosion also occurs. The biostatic coating and oxygen gas inhibitor is applied using a foam base, or as an additive in an aqueous treatment fluid. As pools of residual water evaporate, mineral concentrations of Group 2 of the periodic table: Calcium, Magnesium, Strontium and Barium flash out as scale. These scale deposits can interfere with the hydraulic design of the system and break away to plug sprinkler heads during activation. Bacterium formed tubercles may break away and cause the same problems associated with scale deposition. The formulation of Table 8 is generally preferred in the coating of in place dry fire sprinkler systems:

TABLE 8

| | |
|---|---|
| Benzylcoco alkydimethyl quaternary amine | about 25% by weight |
| C8-C18 | |
| Montmorillonite (Nanocor ™) | about 2.5% by weight |
| Purified Water | about 66.5% by weight |
| Catfoam (Cationic Foamer) | about 1.5% by weight |
| Sodium NTA (food grade) | about 1% by weight |
| N-ethyl-N-hydroxy-ethanamine | about 2% by weight |
| Sodium-N-methyl-oleoyltaurate (technical | about 1.5% by weight |
| grade) | |

Wet fire sprinkler systems are usually filled with potable or non-potable water. This stagnate water stands for long periods of time, providing ideal conditions for MIC causing bacterial growth. Further, high points of the system gather trapped air making it ideal for oxygen gas corrosion to occur at the air to water interface. Dissolved oxygen is added whenever makeup water is added to the system. Mineral scaling is often a problem within these systems where the water is not properly polished. Bacterium tubercle formation can also add to these problems. The formulation of Table 9 is generally preferred in these systems and is preferably applied with a foam carrier, or an aqueous solution (0.5-2.5%).

TABLE 9

| | |
|---|---|
| Benzylcoco alkydimethyl quaternary amine | About 25% by weight |
| C8-C18 | |
| Montmorillonite (Nanocor ™) | About 2% by weight |
| Purified Water | About 63% by weight |
| Catfoam (Cationic Foamer) | About 1.5% by weight |
| Sodium NTA (food grade) | About 1% by weight |
| Tetrakis (Hydroxymethyl) Phosphonium | About 4% by weight |
| Sulfate (technical grade) | |
| Sodium Thiosulfate (technical grade) | About 2% by weight |
| N-ethyl-N-hydroxy-ethanamine | About 1.5% by weight |

### EXAMPLES

The invention now will be described with respect to the following examples; however, the scope of the present invention is not intended to be limited thereby.

### Example 1

### Mixing Procedure

Start with 40% to 88% (by weight) water base.

Add nano-clay powder 0.1% to 25% (by weight) (or equivalent) slowly with backpressure on a Sandpiper or equivalent pump circulating the mixture as it is meshed and dispersed. Mix to form a homogeneous mixture to ensure all solids are suspended and solution is clear.

Add quaternized ammonium salt 10% to 25% (by weight) slowly with backpressure on Sandpiper or equivalent pump circulating mixture as it is meshed and dispersed. Mix to form a homogeneous mixture.

Circulate for 30 minutes.

Add remaining water for batch size.

Circulate for ¾ hour.

Add other additives, as needed, and circulate for ½ hour.

Adjust pH level to 6.8 to 7.2 range using citric acid and sodium bicarbonate as needed.

### Example 2

To illustrate the reduction in gas permeability benefited by the invention, a gas diffusion apparatus was constructed to test formulations and relative gas permeability. The apparatus was constructed of 2 each chambers of PVC (polyvinylchloride) constitution. The chambers had dimensions of 2 inch diameter and a length of 5 inches. They are mounted together by a flange which is closed with 4 fasteners. In between the flange fitting, a rubber gasket and three layers of Parafilm M®, 2″ diameter, (Pechiney Plastic Packaging, Chicago, Ill.). The middle layer of the Parafilm M® is coated on both sides with the formulation to be tested. The other two Parafilm M® layers are applied on each surface of the treated Parafilm M®. This then forms a membrane which may be placed between the gasket and flange parts connected to the chambers. Parafilm M® is a plastic membrane which has a gas diffusion rate of: Oxygen (ASTM 1927-98): 150 cc/m² d at 23° C. and 50% RH Carbon Dioxide (Modulated IR Method): 1200 cc/m² d at 23° C. and 0% RH.

The testing chambers were then employed in the following manner:

1. Gas diffusion apparatus is conjoined by flange at end of right and left units.

2. Membrane to be tested has been placed with gasket at flange joint.

3. Right hand and left hand chambers of gas diffusion unit are evacuated of all pressure, with the exception of atmospheric.

4. Both chambers are sealed shut with needle valves having membrane unit separating the chambers.

5. The right hand chamber was filled with air to a psi of 5.0 psig.

6. The time was recorded for the left hand chamber to obtain a pressure of 2.0 psig. Isolation of left hand chamber assures gas is flowing through membrane between the two chambers.

7. psig of left chamber is then recorded and divided by time for left hand chamber to fill to psig. Example: 2.0 psig/8 minutes=0.25 psig/minute diffusion rate.

Testing was performed using a blank three-layer Parafilm M® and psig/minute was recorded as a base line with no coating. Testing was performed using DI water as a coating in the three-layer Parafilm M® and psig/minute was recorded to determine the affect of a water covered membrane. Testing was performed using base formulation with no nano-clays in formulation

The following formulation was used as a test formulation 1:

Benzylcoco alkydimethyl quaternary amine C8-C18: 25.00% by weight

Montmorillonite (Nanocor™): 0.25% by weight

Purified Water: 72.25% by weight

Methyl Diethanolamine: 2.50% by weight (H2S & CO2 absorber)

The following formulation was used as a test formulation 2:

Benzylcoco alkydimethyl quaternary amine C8-C18: 25.00% by weight

Montmorillonite (Nanocor™): 0.50% by weight

Purified Water: 72.00% by weight

Methyl Diethanolamine: 2.50% by weight (H2S & CO2 absorber)

The following formulation was used as a test formulation 3:

Benzylcoco alkydimethyl quaternary amine C8-C18: 25.00% by weight

Montmorillonite (Nanocor™): 1.00% by weight

Purified Water: 71.50% by weight

Methyl Diethanolamine: 2.50% by weight (H2S & CO2 absorber)

The following formulation was used as a test formulation 4:

Benzylcoco alkydimethyl quaternary amine C8-C18: 25.00% by weight

Montmorillonite (Nanocor™): 0.00% by weight

Purified Water: 72.50% by weight

Methyl Diethanolamine: 2.50% by weight (H2S & CO2 absorber)

Testing was performed on all three formulations and the results are as provided in Table 10.

TABLE 10

| | | | cc/minute |
|---|---|---|---|
| Formulation | PSIG | Time (min) | Diffusion Rate |
| Air (1) | 2.0 | 8.00 | 0.250 |
| Air (2) | 2.0 | 8.05 | 0.248 |
| Air (3) | 2.0 | 8.07 | 0.248 |
| Air Average | N/A | N/A | 0.249 |
| DI Water (1) | 2.0 | 9.10 | 0.220 |
| DI Water (2) | 2.0 | 8.44 | 0.237 |
| DI Water (3) | 2.0 | 9.06 | 0.221 |
| DI Average | N/A | N/A | 0.226 |
| Form. 1 (1) | 2.0 | 24.50 | 0.082 |
| Form. 1 (2) | 2.0 | 28.53 | 0.070 |
| Form. 1 (3) | 2.0 | 25.50 | 0.078 |
| Form. 1 Avg. | N/A | N/A | 0.077 |
| Form. 2 (1) | 2.0 | 26.10 | 0.077 |
| Form. 2 (2) | 2.0 | 21.05 | 0.095 |
| Form. 2 (3) | 2.0 | 23.11 | 0.087 |
| Form. 2 Avg. | N/A | N/A | 0.086 |
| Form. 3 (1) | 2.0 | 82.50 | 0.024 |
| Form. 3 (2) | 2.0 | 79.55 | 0.025 |
| Form. 3 (3) | 2.0 | 83.15 | 0.024 |
| Form. 3 Avg. | N/A | N/A | 0.024 |
| Form. 4 (1) | 2.0 | 14.10 | 0.142 |
| Form. 4 (2) | 2.0 | 16.25 | 0.123 |
| Form. 4 (3) | 2.0 | 16.51 | 0.121 |
| Form. 4 Avg. | N/A | N/A | 0.129 |

Testing Summation:

| | | Average cc/min. |
|---|---|---|
| Formulation | % Nano-Clay (wt) | diffusion rate |
| Air | 0.00 | 0.249 |
| DI Water | 0.00 | 0.226 |
| Formula 4 | 0.00 | 0.129 |
| Formula 1 | 0.25 | 0.077 |
| Formula 2 | 0.50 | 0.086 |
| Formula 3 | 1.00 | 0.024 |

The following observations may be made about the testing results: Formula 4 (without nano-clays) prohibits diffusion of air by 48.2%. Formula 1 (with 0.25% nano-clays) prohibits diffusion of air by 69.1%. Formula 2 (with 0.50% nano-clays) prohibits diffusion of air by 65.5%. The difference between formula 1 and 2 results appears to be within statistical error; but still exceeds formula 4. Formula 3 (with 1.0% nano-clays) prohibits diffusion of air by 90.4%.

Testing confirms that increased weight percentage of nano-clays in formulation decreases gas permeability as a function of time.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A composition comprising:
a quaternary ammonium salt; and
a nano-clay.

2. The composition of claim 1 wherein said nano-clay comprises a smectite.

3. The composition of claim 2 wherein said nano-clay comprises a dioctahedral smectite.

4. The composition of claim 3 wherein said nano-clay comprises montmorillonite

5. The composition of claim 3 wherein said nano-clay comprises nontronite.

6. The composition of claim 1 wherein said nano-clay comprises a chlorite

7. The composition of claim 1 wherein said nano-clay comprises an illite.

8. The composition of claim 1 wherein said nano-clay comprises a kaolin.

9. The composition of claim 1 further comprising an oxygen scavenger.

10. The composition of claim 9 wherein said oxygen scavenger comprises a catalyzed sulfite.

11. The composition of claim 9 wherein said oxygen scavenger is selected from the group consisting of: ascorbic acid, N-ethyl-N-hydroxy-ethanamine, and α-tocopherol.

12. The composition of claim 1 wherein said quaternary ammonium salt comprises benzylcoco alkyldimethyl quaternary amine C8-C18

13. The composition of claim 1 wherein said quaternary ammonium salt comprises Di-C10 dimethyl ammonium chloride.

14. The composition of claim 1 further comprising purified water.

15. The composition of claim 1 further comprising at least one of: Tetrakis(Hydroxymethyl)Phosphonium Sulfate, Citric Acid, Sulfamic Acid. Sodium EDTA, Acetic Acid, Molybdenum Disulfide, Sodium Thiosulfate, Sodium Gluconate, Sodium Dodecylbenzenesulfonate, Sodium Metaphosphates, Sodium Phosphate, Sodium Alkane Sulfonate, Sodium Borate & Sodium Nitrite, Sodium Metasilicate, Sodium-N-methyl-oleoyltaurate, Sodium Orthophosphates, Sodium Orthosilicate, Phosphate Ester, Sodium NTA, Polyvinylpyrrolidone, Zinc Gluconate, Polydimethylsiloxane, Catfoam, monethanol amine, diethanolamine, Methyl Diethanolamine, or Sodium Bicarbonate,

16. A method of inhibiting microbiologically influenced corrosion, oxygen and acid gas corrosive processes on a metallic object, the method comprising:
providing a composition including:
a quaternary ammonium salt; and
a nano-clay; and
applying said composition to said metallic object.

17. The method of claim 16 wherein said composition is foamed during said applying.

18. The method of claim 17 wherein said composition is foamed with at least one of air, nitrogen, or natural gas.

19. The method of claim 16 wherein said composition is provided as a hydrophilic aqueous additive during said applying.

20. The method of claim 16 wherein said composition is dispersed in a micro-emulsion comprising:
a hydrocarbon based solvent;
a co-solvent; and
water.

21. The method of claim 16 wherein said composition is applied during manufacturing of said metallic object.

22. The method of claim 16 wherein said composition is applied after installation of said metallic object.

23. The method of claim 16 wherein said composition is applied to a metallic pipe.

24. The method of claim 16 wherein said composition is applied to an inner wall of said metallic pipe.

25. The method of claim 24 wherein said composition is applied to an outer wall of said metallic pipe

26. The method of claim 25 wherein said composition is applied to said outer wall during manufacturing and said inner wall after installation of said pipe.

27. The method of claim 16 wherein said metallic object comprises at least one of: a fabricated metallic structure or a flat sheet.

28. The method of claim 16 wherein said method is performed on a fire sprinkler system.

29. The method of claim 16 wherein said method is performed on an oil and gas processing system.

30. The method of claim 16 wherein said metallic object includes at least one of: ferrous iron, zinc, stainless steel, copper, brass, or aluminum.
